(19) United States
(12) Patent Application Publication
(10) Pub. No.: US 2012/0313364 A1
(43) Pub. Date: Dec. 13, 2012

(54) Method of Catheter Type and Presence Notification

(76) Inventor: Vincent Tessitore, Slatersville, RI (US)

(21) Appl. No.: 13/429,619

(22) Filed: Mar. 26, 2012

Related U.S. Application Data
(60) Provisional application No. 61/495,751, filed on Jun. 10, 2011.

(51) Int. Cl. B42D 15/00

(52) U.S. Cl. 283/70

(57) ABSTRACT

Disclosed is a method of notifying medical professionals or caregivers of a type of peripherally inserted central and midline catheter being employed on a given patient, preventing unnecessary movement of the extremity, unnecessary or premature removal of an existing catheter line and ensuring proper treatment of the patient if the patient is transferred from one location to another. The method employs an identification bracelet having information related to the inserted catheter, including the type of catheter employed, its size, length and indwell length, as well as the insertion date thereof. Further provided is a notice of a restricted extremity, which prevents the catheter from being tugged or unnecessarily moved while inserted. The method ensures proper care for those receiving infused medications at home or requiring emergency medical treatment services.

### CROSS REFERENCE TO RELATED APPLICATION

This application claims the benefit of U.S. Provisional Application No. 61/495,751 filed on Jun. 10, 2011, entitled “PICC Line or Medline Patient Identification Band.”

### BACKGROUND OF THE INVENTION

1. Field of the Invention

The present invention relates to medical identification wristbands, bracelets and methods of treatment verification. More specifically, the present invention pertains to a method comprising the use of a medical bracelet having particular information regarding a patient's peripherally inserted central catheter or midline catheter line, including the size, length and insertion date for alerting medical professionals of an existing catheter, along with the type of catheter and which extremity is being utilized for the catheter on the given patient.

Peripherally Inserted Central Catheters (PICCs) are a form of intravenous access that provides for long-term medical treatment regimes and therapy that would otherwise be impractical to continually administer and establish. The PICC, specifically, is an elongated intravenous (IV) tube that is inserted into a periphery vein along the arm and advanced toward the heart through increasingly larger veins for direct application of medication that will be carried to the heart and distributed throughout the body. These types of lines are administered by medical professionals for long-term care and treatment of critical conditions, including the use of chemotherapy, antibiotic therapy and perenteral nutrition. The PICC tube itself is a very thin, flexible tube that is generally inserted into one of the veins just above or below the elbow joint. The line can be left inserted for several weeks or months, providing a means to communicate a long-term treatment without continual needle insertion or re-insertion of IV lines that would otherwise be required. Once inserted, the IV tube is advanced until the tip of the tube rests in the distal superior vena cava or cavoatrial junction just prior to the heart.

Midline catheters are similar peripheral venous access devices that are also placed on the upper arm vein such as the brachial or cephalic vein. Midlines are shorter than PICCs and are designed to terminate below near the armpit and do not extend beyond the axillary line, wherein PICCs extend further towards the heart. These types of catheters are limited with respect to the infused solution that can be delivered compared to PICCs, but similarly provide for long-term treatment using a single IV line that can last a number of weeks. Both types of catheters are utilized for extended intravenous medication, tests, transfusions or treatments. Both types are also utilized for those patients with damaged or smaller veins, wherein continual IV introduction is more difficult and burdensome on the patient and medical professionals.

Individuals receiving IV treatments via a PICC or midline catheter need to take precautions over the duration with which the catheter is inserted. Similarly, healthcare professionals and care givers must be aware of the type, specifications and location of the catheter in order to provide adequate care and prevent injury to the IV access point. Generally the extremity being utilized to support the catheter must be restricted from severe movements to prevent the catheter from being snagged or otherwise tugged from the user's arm. Healthcare providers, and in particular home caregivers and emergency medical staff transferring a patient, must be aware of the catheter location, type and specification in order to administer proper care and prevent injury or mistreatment. Proper protection may be compromised if emergency medical treatment (EMT) personnel are unaware of the presence or type of catheter lines inserted in their patient. There exists a need therefore, for a means to identify on a patient the extremity utilizing a catheter, and one that provides pertinent information with regards to the catheter employed. The present invention provides a method of treatment and identification that fulfills this need.

2. Description of the Prior Art

Medical bracelets and identification bands are well described in the art for the purposes of patient identification and ensuring continuity between a patient's care and his or her identity. Specifically, most medical bracelets provide a way to verify a patient's identity to ensure against mistreatment or administration of another patient's medication or treatment. These bracelets have familiar design features for the purposes of securing an identifying structure against a user's wrist or arm, wherein the bracelet includes identifying information about the patient. The identity of the patient can be verified to prevent malpractice or miscommunication. Some bracelets go farther and provide a removable, adhesive tab for transferring the patient's information to medication containers, samples and other related medical treatment elements that are associated with a given patient. None of the bracelets are adapted specifically for the purpose of identifying the type and specifications of an inserted PICC or midline catheter. The present invention provides a method of identifying the inserted catheter to provide notice for healthcare providers and care givers.

Catheters of the foregoing type are generally inserted into the middle arm, near the elbow joint. The catheter tail, which is a length of the tube that extends from the patient insertion point and provides a means to connect IV fluids for communication into the catheter tube, is generally taped against the user's arm to account for minor movement and to securely restrain the catheter against the arm. Large movements or those that do not take into account the sensitivity and placement of the catheter can lead to catheter removal or subsequent patient pain. If a catheter is disturbed and in need of replacement as a result of this movement, the process of insertion must be repeated, adding further pain to the patient being treated. It is therefore desired to disclose a method of utilizing a medical bracelet that is readily identifiable by medical professionals and caregivers that is capable of providing notice of the catheter location and to which extremity it is being deployed.

Medical bracelets of varying type are currently on the market, have been patented and further disclosed in published patent applications. These devices are primarily for patient identification purposes and broader verification systems for cross-checking a patient's treatment articles and medications against a given individual. No devices are provided for the purposes of notifying of an inserted catheter on a patient's extremity, or for providing the type and specification thereof.

U.S. Published Patent Application Publication No. 2006/0230661 to Bekker is one such disclosure that comprises a medical identification bracelet having a sealable window over the patient information area to prevent contact with moisture and other fluids that may smear or otherwise reduce clarity of the information written thereon. The cover is connected to the band along one edge, from which the window is adapted to be lifted away to place pertinent patient bibliographic information therebelow onto the patient information area. A peel-off release film is removed from the underside of the window to reveal an adhesive backing surface, which is then adhered via contact pressure over the printed patient information for protection thereof. The Bekker device is one in which information written on the bracelet is protected from damage or smearing. The bracelet comprises a protective structure in the form of a lift-away and adhesive window. The contents of the band are one of bibliographic importance. No mention is made of a specific catheter identification band for use in alerting medical professionals of the presence or type of catheter employed on a given patient.

U.S. Published Patent Application Publication No. 2007/0120358 to Waggoner further discloses a patient wristband form for pealing adhesive tabs and placing them on removable wristbands for use on medical patients. The form supports a plurality of tabs that include patient information that can be applied to the user's wristband, as well as to a variety of other articles, such as medical equipment, forms, and medicine containers that are intended for the patient. The forms may be printed using a computer printer, wherein the same information may be duplicated on the tabs for multiple copies thereof that can be applied to a plurality of different articles for identification purposes. While providing a means to indicate and mark associated articles against a wristband of a patient, the Waggoner form does not provide any clarity with regard to catheter status, type or catheter identifying elements that may be useful for treatment of those patients with an existing catheter and receiving care including a PICC or midline.

Similar to the Waggoner disclosure, U.S. Pat. No. 3,715,570 to Weichselbaum describes an identification bracelet attaching to the arm of a patient that is adapted to dispense a plurality of magnetically coded tags for which to adhesively attach to various articles related to the patient, including prescriptions, samples and the like to uniquely identify the article with the source individual. The magnetization of the tags allows readers within a hospital or care facility to automatically read and decode the tags in order to correlate an article with a particular and proper patient. The Weichselbaum device doubles as a means to identify articles related to a patient, including records, prescriptions and specimens, while also acting as a failsafe means to properly identify a patient and ensure proper treatment is applied to the correct individual. The magnetic strips ensure a patient is properly identified and proper treatment is applied to the correct patient. While providing a novel medical identification bracelet, the Weichselbaum device fails to disclose a catheter identification band of the type disclosed by the present invention. The Weichselbaum device is primarily for bibliographic information and patient identification rather than a status of a particular treatment being employed on the target patient.

U.S. Pat. No. 4,476,381 to Rubin describes a patient treatment method and system that provides patient identification wrist bracelet that also facilitates generation of labels for identification of specimen containers for verification against the patient's identity and ensuring an accurate linkage therebetween. The patient bracelet provides an ultraviolet sensitive label to transluminate an indicia onto a label. The Rubin device is a novel means that provides tracking of patient specimens with regard to a target patient; however, it is not adapted to provide a caregiver or medical professional notice of a particular type of catheter being utilized on the patient as provided by the present invention.

Finally, U.S. Pat. No. 4,377,047 to Adams, Jr. discloses an identification bracelet that has a band portion and an enclosure that includes a likeness of the wearer for identification verification purposes. The enclosure is integrally molded into the band, and provides medical professionals a means of verifying a patient's name and information by immediately cross-checking the bracelet likeness with the user's facial features. The photograph likeness reduces possible errors with regard to administration of medication and commencement of other procedures on the incorrect patient. The Adams, Jr. device is a novel medical identification device, but fails to disclose pertinent information regarding catheter use or type, while also failing to provide notice providers of administered medication and other pertinent medical information.

The devices disclosed in the prior art are not adapted for adequately alerting a caregiver or medication professional of the existence and specifications of an inserted PICC or midline catheter. It is submitted that the present method substantially diverges in steps and design elements from the prior art, and consequently it is clear that there is a need in the art for an improvement to existing methods of catheter identification and devices therefor. In this regard the instant invention substantially fulfills these needs.

### SUMMARY OF THE INVENTION

In view of the foregoing disadvantages inherent in the known types of medical bracelets now present in the prior art, the present invention provides a new medical bracelet and method of treatment verification wherein the same can be utilized for providing convenience for the user when a PICC, midline or similar catheter is being utilized and for providing identifying information thereof and of the patient for notice to care takers and healthcare professionals.

It is therefore an object of the present invention to provide a new and improved medical bracelet device and method that has all of the advantages of the prior art and none of the disadvantages.

Another object of the present invention to provide a method of medical treatment verification and identification utilizing a specifically designed medical bracelet that provides notice of the presence a peripheral catheter and of a restricted extremity.

Another object of the present invention to provide a method of medical treatment verification and identification utilizing a specifically designed medical bracelet that provides identifying specifications of the inserted catheter for treatment purposes.

Yet another object of the present invention to provide a method of medical treatment verification and identification that reduces pain for the user by preventing a restricted extremity from being handled and for ensuring proper treatment using an existing and previously inserted catheter as a means to introduce medication or therapy for the given patient.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a close-up view of an exemplary catheter medical bracelet embodiment utilized in the present method.

FIG. 2 shows a view of a medical bracelet embodiment in use on a patient's extremity.

FIG. 3 shows a view of a medical bracelet embodiment in use on a patient's extremity while a periphery catheter is inserted into the patient's arm.

### DETAILED DESCRIPTION OF THE INVENTION

Reference is made herein to the attached drawings. Like reference numerals are used throughout the drawings to depict like or similar elements of the catheter medical bracelet. For the purposes of presenting a brief and clear description of the present invention, the preferred embodiment will be discussed as used for identifying a restricted extremity and identifying the type and presence of an inserted peripheral catheter. The figures are intended for representative purposes only and should not be considered to be limiting in any respect.

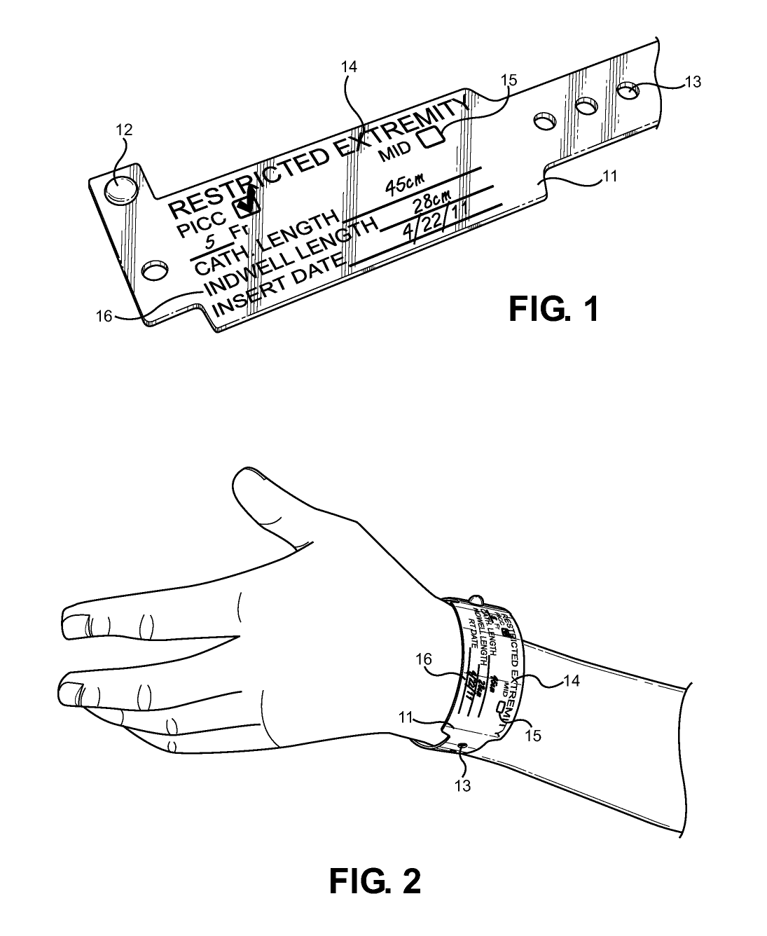

Referring now to FIG. 1, there is shown a close-up perspective view an exemplary embodiment of the catheter notification and verification bracelet that comprises the present method. The bracelet 11 is work around an extremity of a user to identify the extremity being utilized for a peripherally inserted catheter (PICC or midline catheter) to serve as notice for health care professionals and caretakers of an existing catheter and its location. The bracelet 11 is similar to a standard wristband or medical bracelet; however the identifying features are that of the catheter. Written on the bracelet 11 is a large warning 14 and the text “RESTRICTED EXTREMITY” to boldly show the limb in which the catheter is inserted. Drastic and haphazard movements of a limb with a catheter can compromise the catheter, create pain for the user or create a situation in which the catheter needs to be reinserted into the patient.

Information is provided on the identification area 16 of the bracelet 11 that includes identifying information about the inserted catheter to assist health care providers in treating a given patient. These include specifications related to the catheter, such as the type 15 (P ICC or midline), diameter of the catheter, its overall length, indwell depth and insertion date. The diameter of the catheter is generally measured using the French catheter scale, which provides a gauge number that corresponds to a given diameter for larger or smaller catheters and applications thereof. Overall lengths shows how long of a catheter that was utilized, while the indwell depth shows how deep the catheter was inserted. This allows for quick reinsertion of replacement catheters without consulting charts or medical notes. This reduces errors and complications with incorrect catheter replacement and provides a means to measure the effectiveness of a given catheter, and to make educated changes based on the type, size and indwell depth of a previous catheter.

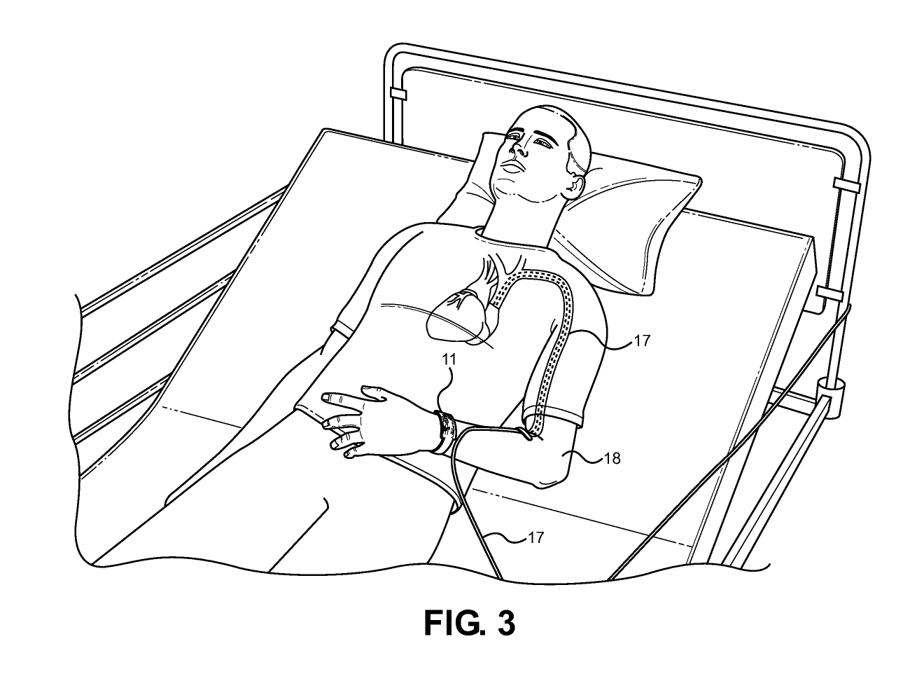

Referring now to FIG. 2, there is shown a view of a catheter identification bracelet of the present method in a working position, wherein the patient has the bracelet attached around an extremity being utilized for peripheral IVs and catheter lines. The bracelet 11, as show in FIG. 1, attaches utilizing a snap fastener 12 that engages a fastener port 13 along the length of the bracelet band wrapping around the periphery of the user's extremity. The snap fastener 12 is adapted to permanently secure around the patient to prevent dislodgment, wherein the bracelet is forcibly removed or cut from the user's wrist. This type of engagement may take several forms, falling within the scope of providing an information area that contains pertinent catheter identifying information and notice thereof, while providing an extremity engagement means that is well disclosed and known in the classification of medical bracelets.

Referring now to FIG. 3, there is shown a view of the present method being utilized on a given patient being treated using a peripherally inserted catheter 17. The user's extremity 18 is marked using the present method bracelet 11, which provides doctors, physician's assistants and nurse anesthetist realize the presence of the catheter and know which type was utilized and its specifications. The bracelet 11 can also be utilized for patients receiving care at home, and is greatly useful for alerting emergency responders (EMTs, trauma doctors) of an existing catheter 17 currently being utilized for treatment. The bracelet 11 is preferably a bright or vibrant color such that it is readily visible.

Different types of medical procedures may require the use of specific types of catheter lines. When treating transferred patients who have already had catheters inserted, medical personnel may be unaware of the specifications of the catheters being deployed. This may prevent patients from receiving proper care based on their specific, individual needs. Additionally, patients who receive infused medications at home and require EMT services may need to protect their restricted extremities during transport and handling. However, proper protection may be compromised if EMT personnel are unaware of the presence or specifications of catheter lines. The present method provides an effective notification solution that provides notice and specifications for the catheter to solve the present risks associated with long-term intravenous treatment articles.

The identification area 16 on the bracelet 11 may include preprinted modules and locations for which to hand-write the specifications of the catheter, or alternatively the information may be printed using a computer printer device. The bracelet and notification method allows medical personnel to immediately identify the specifications of catheter lines used on different patients. The invention comprises a colored identification band designed to be worn on the wrist of the restricted extremity. The band can be wide enough to accommodate handwriting or print, and may include an adjustable locking means. The words, “Restricted Extremity” may be printed in bold, capital letters at the top of the band. Information detailed on the band can include the type of catheter used (PICC or MID), the catheter size (3Fr, 4Fr, etc.), the catheter length, the indwell length, and the insertion date. Medical personnel may check the box of the type of catheter in use, while the other fields of information, such as the date, length, and indwell depth is printed and filled in by medical personnel.

Overall, the present invention provides a new method of treatment verification that is particularly useful for patients receiving long term care and treatment via intravenous medication or therapy. These devices stay imbedded in the body for long periods of time, increasing the chance that they may become snagged or their specification may not be readily recalled. The present method employs a bracelet that is utilized for alerting medical staff of an inserted catheter, along with the type to allow swift replacement if deemed necessary. The present method advances the art of medical bracelets and provides a novel means for communicating a catheter specifications, which is not previously disclosed in the prior art.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method of catheter type and presence notification, comprising the steps of:
providing a bracelet having an identification area and an extremity attachment means;
utilizing said identification area for recording catheter identifying information;
wearing said bracelet around an extremity in which a catheter is inserted.

2) The method of claim 1, further comprising the steps of placing a readily visible warning stating “Restricted Extremity” onto said bracelet identification area.

3) The method of claim 1, wherein said catheter is a peripherally inserted central catheter (PICC).

4) The method of claim 1, wherein said catheter is a midline catheter.
